(19) United States
(12) Patent Application Publication
(10) Pub. No.: US 2025/0142118 A1
(43) Pub. Date: May 1, 2025

(54) A METHOD AND AN APPARATUS FOR ENCODING/DECODING ATTRIBUTES OF A 3D OBJECT

(71) Applicant: InterDigital CE Patent Holdings, SAS, Paris (FR)

(72) Inventors: Jean-Eudes Marvie, Betton (FR); Yannick Olivier, Thorigne Fouillard (FR); Jean-Claude Chevet, Betton (FR)

(21) Appl. No.: 18/835,492

(22) PCT Filed: Jan. 26, 2023
(86) PCT No.: PCT/EP2023/051940

§ 371 Date: Aug. 2, 2024

(30) Foreign Application Priority Data
Feb. 3, 2022 (EP) 22305116.0

(51) Int. Cl. H04N 19/597; G06T 17/20; H04N 19/70

(52) U.S. Cl. CPC H04N 19/597; G06T 17/20; H04N 19/70

(57) ABSTRACT

Methods and apparatuses for encoding or decoding 3D objects are provided. The 3D object having attribute values represented at a first bit-depth, modified attribute values are obtained for at least one subset of the attribute values, the modified attribute values being represented at a second bit-depth that is smaller than the first bit-depth, and metadata associated to the at least one subset of the attribute values are obtained, the metadata comprising an information representative of a modification applied to the attribute values of the at least one subset to obtain the modified attribute values at the second bit-depth. The modified attribute values and the metadata are encoded.

### TECHNICAL FIELD

The present embodiments generally relate to a method and an apparatus for encoding and decoding of 3D objects, and more particularly encoding and decoding of 3D objects represented as t meshes.

### BACKGROUND

Free viewpoint video can be implemented by capturing an animated model using a set of physical capture devices (video, infra-red, . . . ) spatially dispatched. The animated sequence that is captured can then be encoded and transmitted to a terminal for being played from any virtual viewpoint with six degrees of freedom (6 dof). Different approaches exist for encoding the animated model. For instance, the animated model can be represented as image/video, point cloud, or textured mesh.

In the Image/Video based approach, a set of video stream plus additional meta-data is stored and a warping or any other reprojection is performed to produce the image from the virtual viewpoint at playback. This solution requires heavy bandwidth and introduces many artefacts. In the point cloud approach, an animated 3D point cloud is reconstructed from the set of input animated images, thus leading to a more compact 3D model representation. The animated point cloud can then be projected on the planes of a volume wrapping the animated point cloud and the projected points (a.k.a. patches) encoded into a set of 2D coded video streams (e.g. using HEVC, AVC, VVC . . . ) for its delivery. This solution is for instance developed in the MPEG V-PCC standard (“ISO/IEC JTC1/SC29 WG11, w19332, V-PCC codec description,” Alpbach, Austria, April 2020). However, the nature of the model is very limited in terms of spatial extension and some artefacts can appear, such as holes on the surface for closeup views.

In the textured mesh approach, an animated textured mesh is reconstructed from the set of input animated images such as in [1]A. Collet, M. Chuang, P. Sweeney, D. Gillett, D. Evseev, D. Calabrese, H. Hoppe, A. Kirk and S. Sullivan, “High-quality streamable free-viewpoint video,” in ACM Transaction on Graphics (SIGGRAPH), 2015. This kind of reconstruction usually passes through an intermediate representation as voxels or point cloud. A feature of meshes is that geometry definition can be quite low and photometry texture atlas can be encoded in a standard video stream. Point cloud solutions could require “complex” and “lossy” implicit or explicit projections (as in V-PCC) to obtain planar representation compatible with video-based encoding approaches. In counterpart, textured meshes encoding relies on texture coordinates (UVs) to perform a mapping of the texture image to the triangles of the mesh.

### SUMMARY

According to an embodiment, a method for encoding attributes of a 3D object is provided. The attributes being represented at a first bit-depth, the method comprises obtaining modified attribute values, the modified attribute values being represented at a second bit-depth that is smaller than the first bit-depth, obtaining metadata associated to the at least one subset of the attribute values, the metadata comprising an information representative of a modification applied to the attribute values of the at least one subset to obtain the modified attribute values at the second bit-depth, and encoding the modified attribute values and the metadata.

According to another embodiment, an apparatus for encoding attributes of a 3D object is provided. The apparatus comprises one or more processors configured to, for at least one subset of the attribute values, the attributes being represented at a first bit-depth, obtain modified attribute values for the at least one subset of the attribute values, the modified attribute values being represented at a second bit-depth that is smaller than the first bit-depth, obtain metadata associated to the at least one subset of the attribute values, the metadata comprising an information representative of a modification applied to the attribute values of the at least one subset to obtain the modified attribute values at the second bit-depth, and encode the modified attribute values and the metadata.

According to another embodiment, a method for decoding attributes of a 3D object is provided. The method comprises decoding at least one subset of attribute values of the 3D object, and metadata associated to the at least one subset, the metadata comprising an information representative of a modification applied to attribute values at a first bit-depth of the at least one subset to obtain modified attribute values at a second bit-depth, the second bit-depth being smaller than the first bit-depth, the decoded attribute values being represented at the second bit-depth, and obtaining reconstructed attribute values using the metadata and the decoded attribute values of the at least one subset, the reconstructed attribute being represented at the first bit-depth.

According to another embodiment, an apparatus for decoding attributes of a 3D object is provided. The apparatus comprises one or more processors configured to decode at least one subset of attribute values of the 3D object, and metadata associated to the at least one subset, the metadata comprising an information representative of a modification applied to attribute values at a first bit-depth of the at least one subset to obtain modified attribute values at a second bit-depth, the second bit-depth being smaller than the first bit-depth, the decoded attribute values being represented at the second bit-depth, and obtain reconstructed attribute values using the metadata and the decoded attribute values of the at least one subset, the reconstructed attribute being represented at the first bit-depth.

According to another embodiment, a bitstream comprising coded metadata associated to at least one subset of attribute values of a 3D object, the attribute values being represented at a first bit-depth, the metadata comprising an information representative of a modification applied to the attribute values of the at least one subset to obtain modified attribute values at a second bit-depth that is smaller than the first bit-depth, and coded video data representative of the modified attribute values of the at least one subset.

One or more embodiments also provide a computer program comprising instructions which when executed by one or more processors cause the one or more processors to perform any one of the encoding method or decoding method according to any of the embodiments described above. One or more of the present embodiments also provide a computer readable storage medium having stored thereon instructions for encoding or decoding attributes of a 3D object according to the methods described herein. One or more embodiments also provide a computer readable storage medium having stored thereon a bitstream generated according to the methods described herein. One or more embodiments also provide a method and apparatus for transmitting or receiving the bitstream generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates an example of a method for encoding a 3D object, according to an embodiment.

FIG. 5 illustrates an example of position attributes quantized with 12 bits (Draco CL parameter equal to 7).

FIG. 6 illustrates an example of texture coordinates attributes quantized with 12 bits (Draco CL parameter equal to 7).

FIG. 7 illustrates an example of a method for encoding a 3D object, according to an embodiment.

FIG. 8 illustrates an example of a method for decoding a 3D object, according to an embodiment.

FIG. 9 illustrates an example of a concatenation of MSB for position attributes, according to an embodiment.

FIG. 10 illustrates an example of a concatenation of MSB for texture coordinates attributes, according to an embodiment.

FIGS. 11 and 12 illustrate an example of a method for obtaining the modified attribute at second bit-depth values and the corresponding metadata, according to an embodiment.

FIG. 13 illustrates an example of a method for reconstructing the attribute values at first bit-depth.

FIG. 14 illustrates an example of position attributes split into 4 chunks.

FIG. 15 illustrates of a method for obtaining the modified attribute at second bit-depth values and the corresponding metadata, according to another embodiment.

FIG. 16 shows two remote devices communicating over a communication network in accordance with an example of the present principles.

FIG. 17 shows the syntax of a signal in accordance with an example of the present principles.

FIG. 18 illustrates an embodiment of a method (1800) for transmitting a signal according to any one of the embodiments described above.

### DETAILED DESCRIPTION

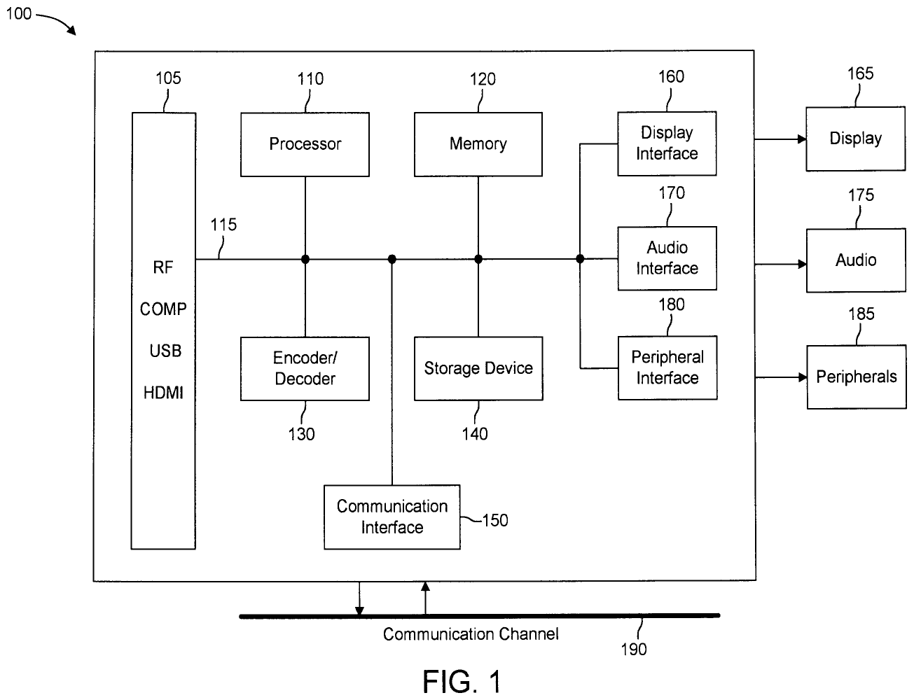

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video/3D object or decoded video/3D object, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video/3D object, the decoded video/3D object or portions of the decoded video/3D object, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for coding and decoding operations, such as for instance MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

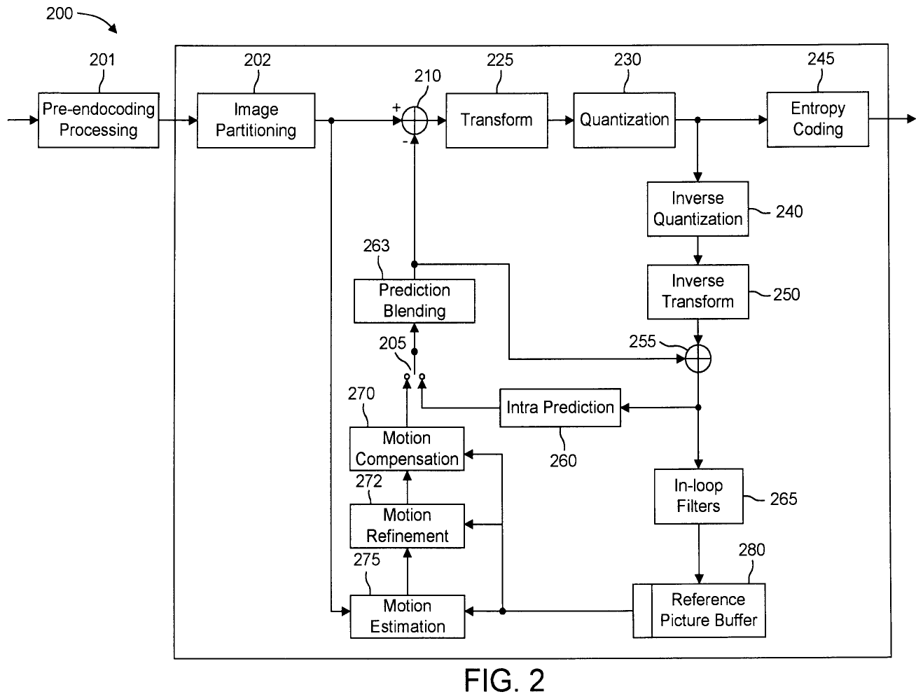

FIG. 2 illustrates an example video encoder 200, such as a High Efficiency Video Coding (HEVC) encoder, that can be used for encoding one or more attributes of an animated mesh according to an embodiment. FIG. 2 may also illustrate an encoder in which improvements are made to the HEVC standard or an encoder employing technologies similar to HEVC, such as a VVC (Versatile Video Coding) encoder under development by JVET (Joint Video Exploration Team).

In the present application, the terms “reconstructed” and “decoded” may be used interchangeably, the terms “encoded” or “coded” may be used interchangeably, the terms “pixel” or “sample” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods.

Prediction residuals are calculated, for example, by subtracting (210) the predicted block from the original image block. The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

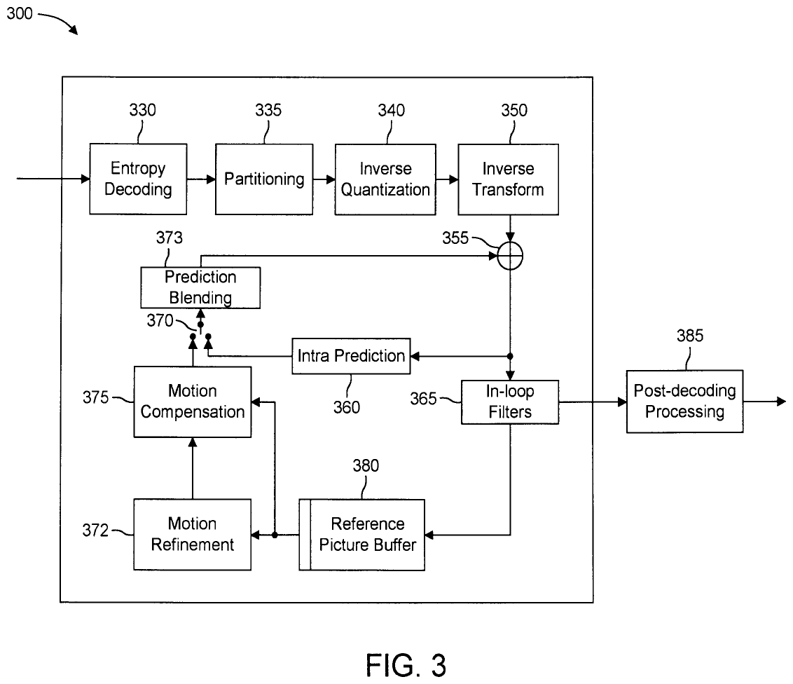

FIG. 3 illustrates a block diagram of an example video decoder 300, that can be used for decoding one or more attributes of an animated mesh according to an embodiment. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

The present application provides various embodiments for encoding/decoding one or more attributes of a 3D object or an animated 3D object, i.e. a 3D object evolving over time. According to an embodiment, the 3D object is represented as an animated 3D mesh. The following embodiments are described in the case of a 3D object represented as a 3D mesh. In some variants, the 3D mesh can be derived from a point cloud of the 3D object.

A mesh comprises at least the following features: a list of vertex positions, a topology defining the connection between the vertices, for instance a list of faces, and optionally photometric data, such as texture map or color values associated to vertices. The faces defined by connected vertices can be triangle or any other possible forms. For easiest encoding, the photometric data is often projected on texture map so that the texture map can be encoded as video image.

According to an embodiment, video-based coding/decoding is used for encoding/decoding at least one component of attributes of the animated mesh. By An animated mesh is a mesh that evolves over time. The mesh comprises attributes associated to the vertices of the mesh. Attributes associated to a vertex can comprise: vertex's position (x,y,z) in the 3D space, also referred to geometry coordinates, texture coordinates (U,V) in the texture atlas associated, normal, color data or generic attribute. Some attribute may have only one component, other attributes may have several components, such as vertex's position having 3 components (x, y, z) or texture coordinates having two coordinates (U,V).

An example of an end-to-end chain for encoding and transmitting an animated textured mesh is presented in [1]. In this scheme, meshes are tracked over time such that the topology of the meshes is consistent. Texture atlases are encoded as video frame, using an H.264 based encoder. The mesh is encoding by splitting the mesh sequence into a series of keyframes and predictive frames. The keyframe meshes contain both geometry and connectivity information. The geometric information (vertex positions and UV coordinates) quantized to 16 bits is encoded. Connectivity information is delta-encoded using variable-byte triangle strip. The predictive frames contain only delta geometry information. Linear motion predictor is used to compute the delta geometry, which is then quantized and compressed with Golomb coding. In [1], the mesh is encoded as meta-data and not using video coding schemes.

In J. Rossignac, “Edgebreaker: Connectivity compression for triangle meshes,” GVU center, Georgia Institute of Technology, 1999 and in J. Rossignac, “3D compression made simple: Edgebreaker with ZipandWrap on a corner-table,” in Proceedings International Conference on Shape Modeling and Applications, Genova, Italy, 2001, implementations of a scheme called EdgeBreaker, for encoding static meshes are proposed. Edgebreaker provides an algorithm to encode static mesh topology as spiraling triangle-strips over the mesh topology. The tri-strip chains topology is coded using a very short code and the attributes of the vertices that are visited (position, UVs, normal, colors) through the process are delta-encoded. The delta-encoded attribute tables are then compressed with the use of any entropy coder. The input data structure of the algorithm is a corner table representation of the input mesh.

The EdgeBreaker algorithm uses a so-called CLERS table. Edgebreaker visits the triangles in a spiraling (depth-first) triangle-spanning-tree order and generates a string of descriptors, one per triangle, which indicate how the mesh can be recreated by attaching new triangles to previously reconstructed ones. A characteristic of Edgebreaker lies in the fact that all descriptors are symbols from the set {C,L,E,R,S}. No other parameter is needed. Because half of the descriptors are Cs, a trivial code (C=0, L=110, E=111, R=101, S=100) guarantees an average of 2 bits per triangle.

In the EdgeBreaker method, vertices positions of the mesh and UV coordinates are delta-encoded, i.e. a value of component of a position (x, y, or z) or a component of the UV coordinates (U, V) of a current vertex being parsed is predicted by a value of a corresponding component of the vertex that has just been previously parsed.

A method for encoding or decoding a 3D object is described below according to an embodiment. For example, the method for encoding the 3D object according to this embodiment can use a framework as presented in [1], but any other end-to-end framework could also be used.

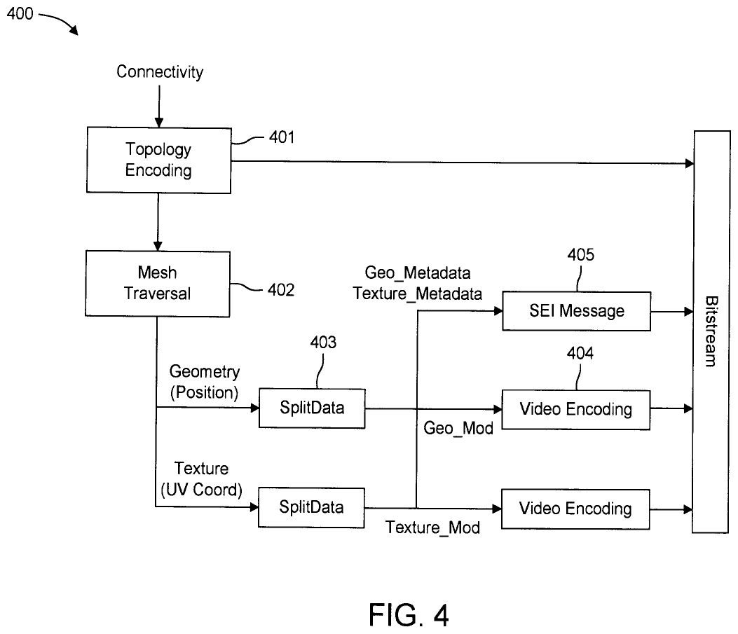

FIG. 4 shows an example of a method 400 for encoding a 3D object according to an embodiment. The 3D object is represented as an animated mesh whose texture atlas is encoded in a video stream using for instance a HEVC or VVC coder (not shown in FIG. 4). The topology/connectivity of the mesh for keyframes, i.e. the frames where topology changes, is encoded (401). For instance, an Edgebreaker method explained above can be used for encoding the topology, but any topology encoding can be used. The topology is stored in a synchronized meta-data associated with the video stream, such as an SEI message, in a bitstream.

The attributes of the mesh, such as geometry (positions of 3D vertex of the mesh), and texture (i.e. UV coordinates of vertices in the texture map or texture atlas), are encoded (404) without any prediction, into additional lossless video streams (using HEVC or VVC coder). Geometry positions and UV coordinates are obtained during the traversal (402) of the mesh when encoding the topology. In this way, the order of geometry positions and UV coordinates is the same at the encoder and decoder and known to the decoder. Thus, no additional metadata is needed to indicate the traversal order of the mesh. In other words, according to a variant that uses the EdgeBreaker method for traversing the mesh, the delta-encoding of the attributes of the Edgebreaker is not used. After the traversal of the mesh for encoding the topology, a sequence of the attribute values associated to each parsed vertex of the mesh is obtained. Each attribute value (geometry or UV coordinates) can have multiple components, for instance x, y, z for geometry and U, V for UV coordinates.

These values correspond to the original values of the attributes associated to the vertices of the mesh. In some variants, the original values obtained may have been quantized (not shown). For instance, when using the EdgeBreaker method for the traversal of the mesh, the sequence of attribute values is represented with a number of bit per component corresponding to the quantization that controls the Edgebreaker algorithm. This quantization can be performed during the traversal and the topology encoding of the mesh.

Each attribute is then split (403) into subsets providing modified attribute values (geo_mod, texture_mod in FIG. 4) whose bit-depth is lower than the input bit-depth of the attribute values. Metadata is also provided for each subset (geo-metadata, texture_metadata in FIG. 4) and encoded (405) in SEI message for instance, so that the attribute values are reconstructed at their input bit-depth on the decoder side. When quantization occurs, input bit depth means the bit depth used for representing the quantized values. The input values could have been already pre-quantized, in that no quantization occurs in the method 400 illustrated in FIG. 4, in that case the input bit depth means the original bit-depth of the values.

At 404, according to an embodiment, the modified attribute values (geo_mod, texture_mod) are packed into components of images and encoded using video-based encoding method. Since attribute values of the 3D mesh are packed in components of images, any video coders could be used for coding the attributes, such as HEVC, VVC or next generation video coders. In other embodiments, the attributes can be coded using any suitable methods other than video-based encoding.

According to the principles described herein, the attribute signal is reframed to adapt it to any bit-depth video codec in lossless mode (e.g HEVC 10 bits) using a filtering by windows of the attribute signal. In some embodiments, for a sequence of attribute values of a 3D object, the sequence of attribute values is split into one or more subsets, wherein the range of attribute values within each subset is reduced so that the attribute values of the subset can be represented on a lower number of bits, and metadata is generated for the subset so that input bit depth of the attribute values is retrieved at the decoder side. According to the present principles, so kind of compression can be achieved losslessly before providing the reframed signal to the video coder.

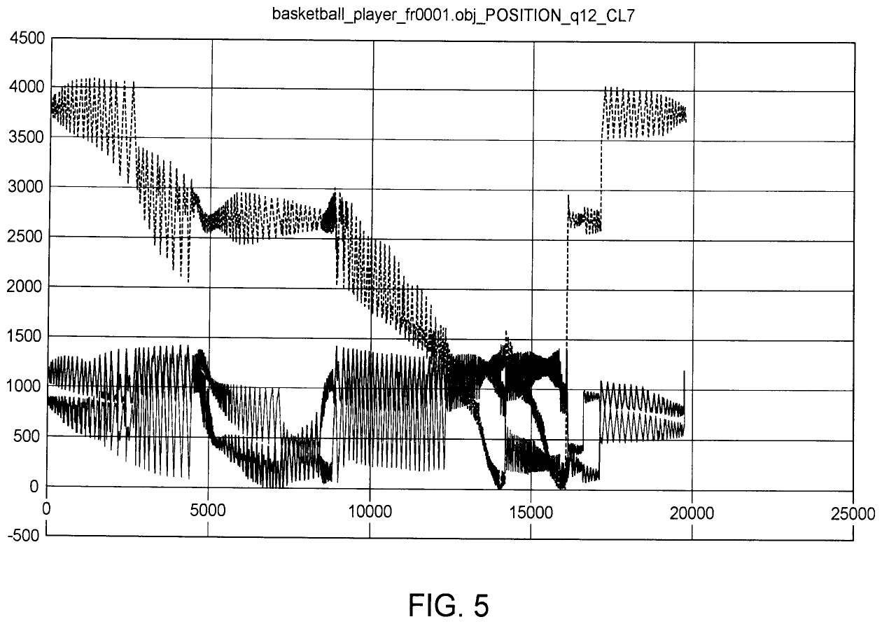

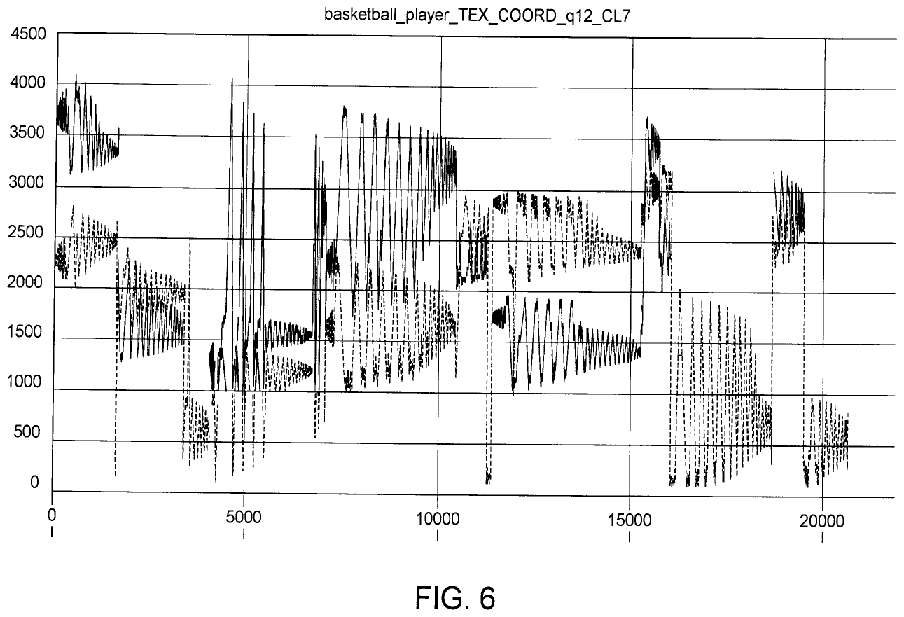

An example of an attribute signal resulting from an Edgebreaker encoding without the delta-encoding is analyzed below. For the experiments and implementation, a Draco implementation (version 1.4.3) of Edgebreaker with CL parameter set to 7 is used. FIG. 5 shows the Vertex Position signal and FIG. 6 shows the texture coordinate signal. One can observe that the Edgebreaker's nature to go spiraling over the mesh introduces locality within the resulting signals hence showing some potential data clusters. According to the principle described herein, these clusters are leveraged to cut the signal into sub-windows or subsets with lower dynamic range for each cluster/subset, thus avoiding any need for quantization that would introduce data degradation.

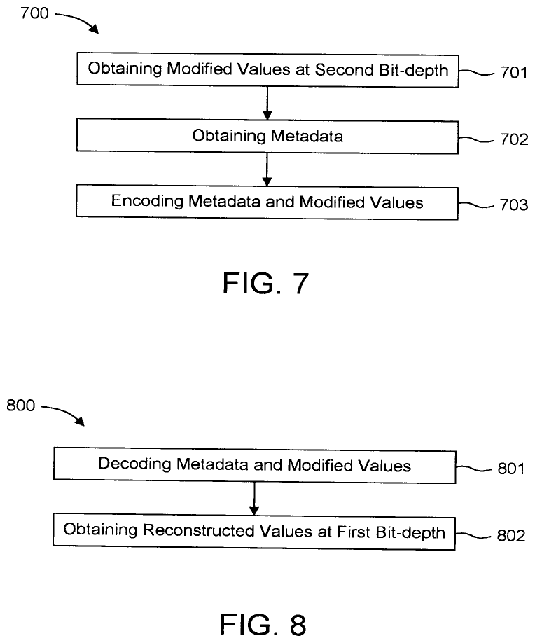

FIG. 7 illustrates an example of a method 700 for encoding attributes of a 3D object, according to an embodiment. The method is performed for at least one type of attributes of the 3D object, wherein the attribute values are represented at a first bit-depth. At 701, modified attribute values are obtained for at least one subset of the attribute values. The obtained modified attribute values are represented at a second bit-depth that is smaller than the first bit-depth. For that, a modification is thus applied to the attribute values of the at least one subset to reduce the range of the attribute values of the subset to a range corresponding to the second bit-depth. At 702, metadata associated to the at least one subset of the attribute values are obtained. The obtained metadata comprise an information that is representative of the modification applied to the attribute values of the at least one subset when obtaining the modified attribute values at the second bit-depth. Such information allows at the decoder to retrieve the attribute values of the subset at their original/input bit-depth, i.e. first bit-depth. At 703, the modified attribute values and the metadata are encoded in one or more bitstream. According to an embodiment, the modified attribute values are encoded using a video-based encoder that operates at the second bit-depth. According to this embodiment, the method 700 further comprises packing the attribute values in at least one component of an image of a video.

According to an embodiment, the metadata is encoded in a SEI message of the video-based encoder.

FIG. 8 illustrates an example of a method 800 for decoding attributes of a 3D object, according to an embodiment. At 801, at least one subset of attribute values of the 3D object is decoded from a bitstream. Metadata associated to the at least one subset are also decoded from the bitstream or from another bitstream.

According to an embodiment, the attribute values are decoded using a video-based decoder operating at the second bit-depth. According to this embodiment, the method 800 further comprises unpacking the attribute values from at least one component of an image of a video. According to an embodiment, the metadata is decoded from a SEI message of the video-based decoder.

The metadata comprise an information that is representative of a modification applied to attribute values at a first bit-depth of the at least one subset to obtain modified attribute values at a second bit-depth, the second bit-depth being smaller than the first bit-depth. The decoded attribute values are represented at the second bit-depth. At 802, reconstructed attribute values are obtained using the metadata and the decoded attribute values of the at least one subset, wherein the reconstructed attribute are represented at the first bit-depth.

The encoding method provided herein allows encoding an n-bit signal on n-k bit dynamic without loss of precision on a non-predicted signal. It thus reduces the size (payload) of the overall signal. It also allows to lossy encode such signal after windowing since not using delta or predictions but global values preventing errors cascading.

Several variants are possible for determining the subset of attribute values and obtained the attribute values from a first bit-depth to a smaller second bit-depth.

A first variant called in the following fixed size window is described below. An aim of this variant is to store in a table the Most Significant Bits (MSB) of the attribute value and its position in the sequence of attribute values of the 3D object when the MSB of at least one component of the current attribute value is different from the previous attribute value of the same component.

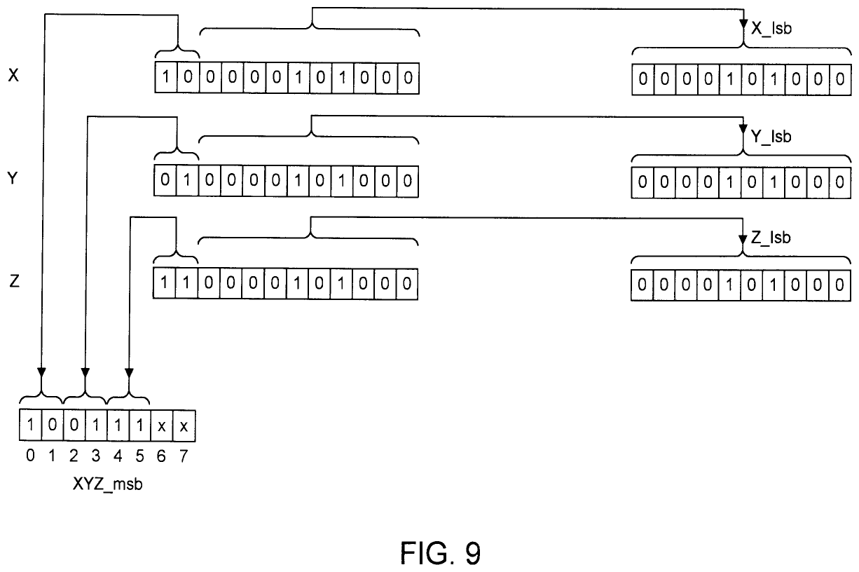

According to an embodiment, the MSB of the different components of the attribute signal (position, UV coordinates etc) are concatenated. FIG. 9 illustrates an example of a concatenation of MSB for position attributes, according to this embodiment. On FIG. 9, an example of 12 bits Position attributes that is adapted to encode with a HEVC 10 bits encoder is illustrated. The MSB bits in this example are the 2 MSB per XYZ component. The 2-bits MSB of the 3 components are concatenated in one code (XYZ_msb).

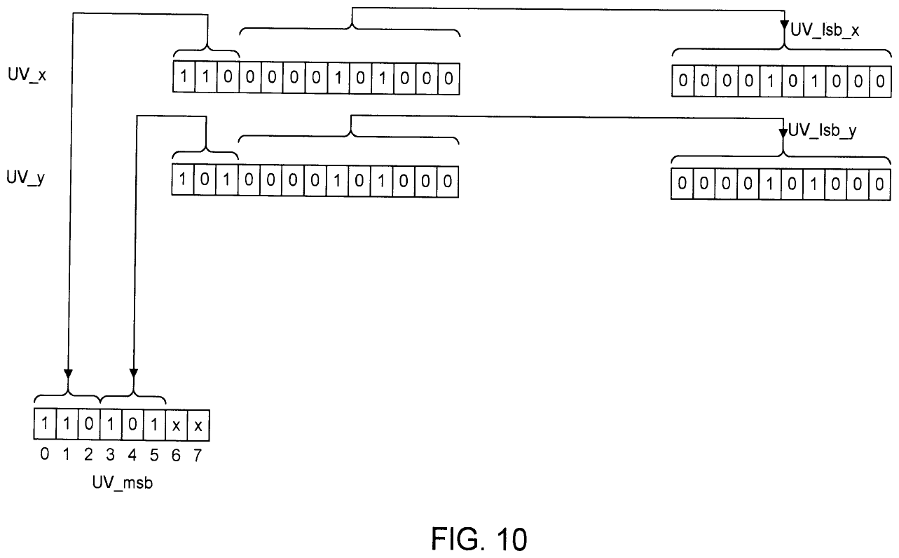

FIG. 10 illustrates an example of a concatenation of MSB for texture coordinates attributes, according to this embodiment. Another example of 13 bits UV texture coordinates attributes (UV_x, UV_y) to encode with a HEVC 10 bits encoder is described on FIG. 10. The MSB bits in this example are the 3 MSB per UV coordinates component. The 3-bits MSB of the 2 components are concatenated in one code (UV_msb).

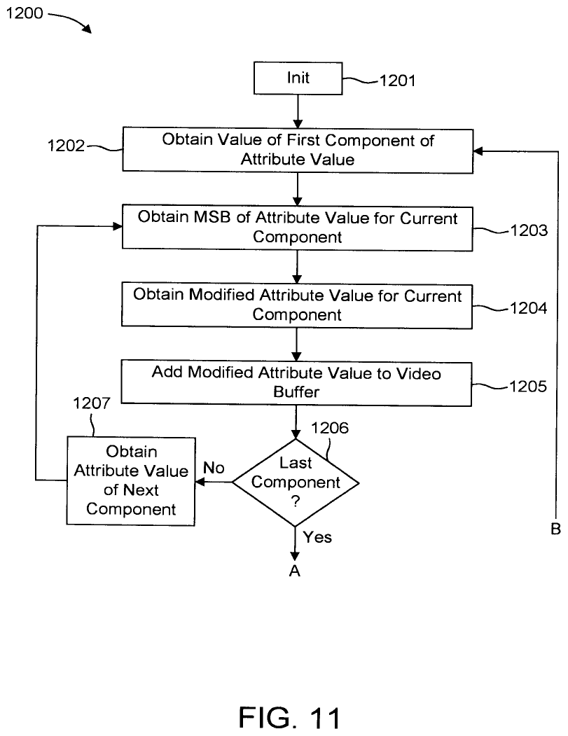

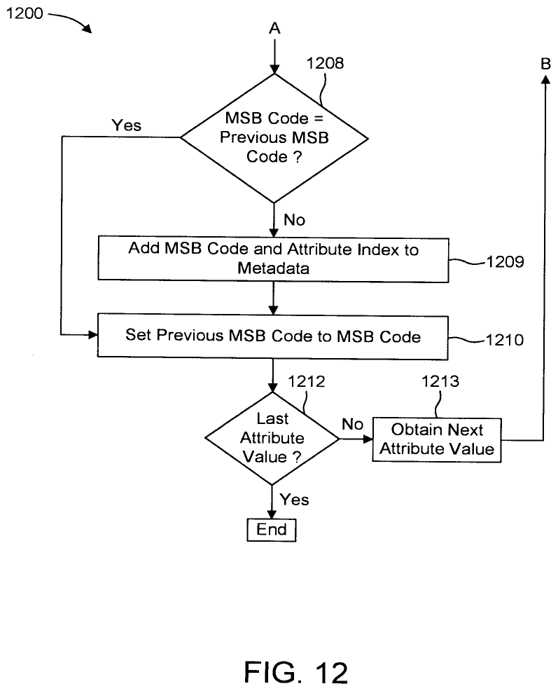

FIGS. 11 and 12 illustrate an example of a method 1200 for obtaining the modified attribute at second bit-depth values and the corresponding metadata, according to an embodiment. This embodiment allows to split the sequence of attribute values into one or more subset of attribute values and obtained the metadata and modified attribute values.

At 1201, some variables are initialized as follows:
attIdx is the index of a current attribute value in the sequence of attribute values, it is initially set to 0.
attBitDepth is the input bit depth of the components of the attributes stream, it is to be noted that in the encoding scheme the attributes values could have been previously quantized so in that case attBitDepth is equal to the bit depth of the quantized values.
rangeBit is the bit depth of the video encoder used to encode the attributes video (Least Significant Bits LSB), it is the target bit depth.
bitsPerMsb is the number of bits for encoding the MSB of each attribute's component of an attribute value at attIdx position in the sequence of attribute values,
maxDeltaIdx is the maximum value of delta index (a deltaIdx value cannot go over this value), for instance it is set to 255.
IsbMask is a mask value used to obtain the LSB value of one attribute' component of the attribute value at attIdx position in the sequence of attribute values, IsbMask is set to (1<rangeBit)−1), wherein << is a binary shift.
msbMask is a mask value to obtain the MSB of one attribute' component of the attribute value at attIdx position in the sequence of attribute values, msbMask is set to (1<<bitsPerMsb)−1.
previousMsb is the MSB code of the previous attribute value, it is initially set to undefined.
previousIndex is the index of the previous attribute value which has a different MSB value from the current one, it is initially set to undefined.

A loop is performed on all the values of an attribute type of the 3D object. At 1202, the value of a first component of a current attribute of the attribute type is obtained (the current attribute value is determined by the index of attIdx in the sequence of attribute values).

Next, one MSB code for an index position of an attribute value is determined. Depending on its type, an attribute value is composed of multiple components (3 components for the POSITION attributes, 2 components for the texture UV coordinates component, etc). The MSBs of all components of one attribute value are concatenated in one MSB code. For this, at 1203, the MSB of the current attribute value for a current component of this attribute value is obtained by for instance: msb=att[c]rangeBit where att[c] is the value of the attribute value for the current component c, and >> is a binary bit shift to the right. That is, the N most significant bits of the component c of the current attribute value att are obtained, wherein N is an integer equal to rangeBit. stored in the metadata in a form of a code concatenating the N most significant bits of each component of said attribute value.

The MSB of the current component of the current attribute value is concatenated in a MSB code (attMsb) with the MSB of the other components of the current attribute value: attMsb=msbbitsPerMsb|(msb&msbMask), with << being a binary bit shift to the left, | a bitwise logical or operator, and & a bitwise logical and operator.

At 1204, the modified attribute value Isb[c] for the current attribute value and current component is obtained, for instance by Isb[c]=att[c]& IsbMask. The modified attribute values Isb[c] correspond to the M−N least significant bits of the attribute values, M being the number of bits used for representing the attribute values at the first bit-depth (attBitDepth) and N being the number of most significant bits used for determining the MSB code for the attribute value (N corresponds to bitsPerMsb). It can be seen that the obtained modified attribute value is thus at a bit-depth that is smaller than the original bit-depth of the attribute value att[c]since it is represented on a lower number of bits.

At 1205, the modified attribute value Isb[c] is added to the video buffer for subsequent encoding. For instance, the modified attribute value is packed in a component of an image for later video encoding.

At 1206, it is checked whether all components of the current attribute value have been considered. If not, then the process passes to 1207 wherein the value for the next component of the current attribute value is obtained similarly as in 1202. Otherwise, the process passes to the next steps (1208) wherein it is determined whether a new subset has to be determined or not and if yes, the metadata for the current subset are determined and stored.

For that, at 1208, it is checked whether the MSB code of the current attribute value is different to the MSB code of the previous attribute value (at previous attIndx). If the MSB code of the current attribute value is the same as the previous MSB code, then no new subset needs to be defined and at 1210, the previous MSB code variable is set to the current MSB code, and the variable attIndex indicating the current attribute value in the sequence of attribute values is increased by 1.

At 1212, it is checked whether all the attribute values have been considered. If not, then at 1213 the next attribute value is obtained (the one at attIdx) and steps 1202-1208 are iterated for this attribute value.

At 1208, if it is determined that the MSB code of the current attribute value is not the same as the previous MSB code, then at 1209, a new subset of attribute values has to be defined and metadata for the new subset are stored. According to this embodiment, the metadata for the new subset comprises the MSB code (attMsb) of the current attribute value which is thus stored in an msb table and the index (attIdx) of the current attribute value which is stored in an index table. Thus, the metadata for the new subset comprises the index indicating a location of the first attribute value of the new subset in the sequence of the attribute values. Then the process passes to step 1210.

At 1212, when it is determined that all the attribute values of the sequence have been considered, the process ends.

According to a variant, a delta index is stored instead of the index (attIdx) to limit the size of the index table.

At 1209, the delta index value deltaIdx is set deltaIdx=attIdx-previousIdx wherein previousIdx is the index of the previous attribute value in the sequence and the delta index is stored in the index table instead of the index value.

According to a further variant, to control the size of the index table, a maximum value for the delta index value is defined (maxDeltaIdx). At 1209, when before storing the metadata, it is checked whether the deltaIdx is higher than or equals to maxDeltaIdx. If the deltaIdx is lower than maxDeltaIdx, the deltaIdx is stored in the metadata with the MSB code and the process passes to the next attribute value. Otherwise, until deltaIdx is not lower than maxDeltaIdx, the maxDeltaIdx is stored in the index table, the previous MSB code is stored in the msb table and the deltaIx is set to deltaIdx-maxDeltaIdx.

According to the embodiment described with FIGS. 11 and 12, since all components of attribute values have been split in subsets in a joint manner, the metadata determined for a subset is the same for all components of the attribute values of the subset.

The method 1200 is performed for at least one type of attributes of the 3D object. It can be performed for only one type of attributes: for instance for only the positions or for only the UV coordinates, or it can be iterated on each one of the types of attributes of the 3D object.

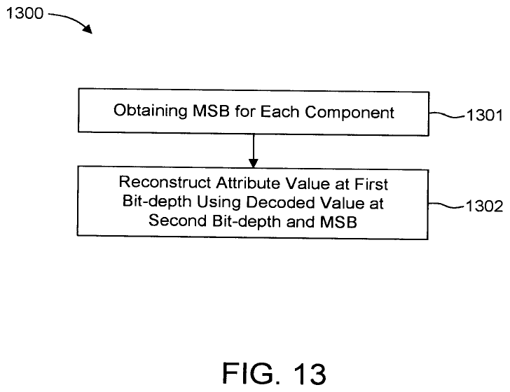

FIG. 13 illustrates an example of a method 1300 for reconstructing the attribute values at first bit-depth, according to an embodiment. In this embodiment, the modified attribute values and metadata have been determined according to the embodiment described in reference with FIGS. 11 and 12. It is assumed, the modified attribute values and metadata have been previously extracted from a bitstream.

The steps loops on each subset of attributes values and for each subset, at 1301, the N most significant bits of the component of the first attribute value are obtained from the metadata. N is an integer that can be obtained from the bitstream or known by the decoder. For each decoded attribute value of the subset, the reconstructed attribute value for each component of the reconstructed attribute value is obtained from the N most significant bits obtained at 1301 and the decoded attribute value. As described with FIGS. 11 and 12, the decoded attribute value corresponds to the M−N (M minus N) least significant bits of the original attribute values. Thus, the decoded attribute value corresponds to the M−N least significant bits of the reconstructed attribute value, wherein M is the number of bits used for representing the original or reconstructed attribute values at the first bit-depth. The integer M can be decoded from the bitstream or known by the decoder.

Another variant called in the following sliding window for reducing the range of the attribute values is described below. According to this variant, each component (x,y,z or U,V) of attributes (position, UV coordinates) is considered separately. An aim is to split each attribute's component into several chunks/subsets (so called window) so that the range of the modified attribute values inside the chunks does not exceed the range of the video encoder used to encode the attributes video. For that, the minimum attribute value in the chunk and the index position of the first attribute associated to each chunk are stored. Subtracting this minimum value to each value in a chunk allows reframing the attribute signal to adapt it to any bit-depth video codec in lossless mode (e.g HEVC 10 bits).

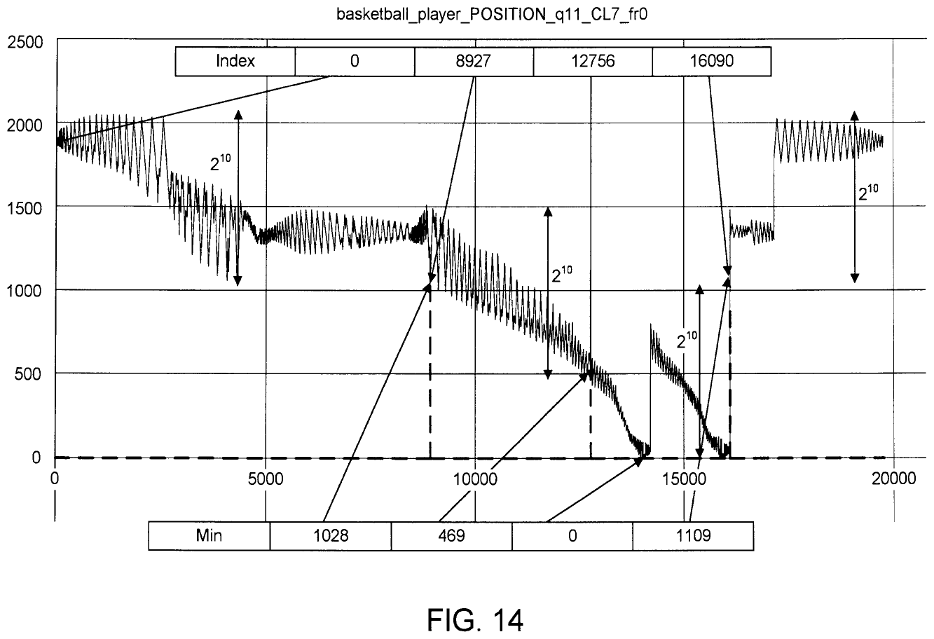

FIG. 14 illustrates an example of position attributes split into 4 chunks. The attribute component (component POSITION Y in the example) is divided into 4 chunks, the range of the values inside each chunk does not exceed 2¹⁰. For each chunk, the minimum attribute value and the index position of the first attribute of the chunk are stored.

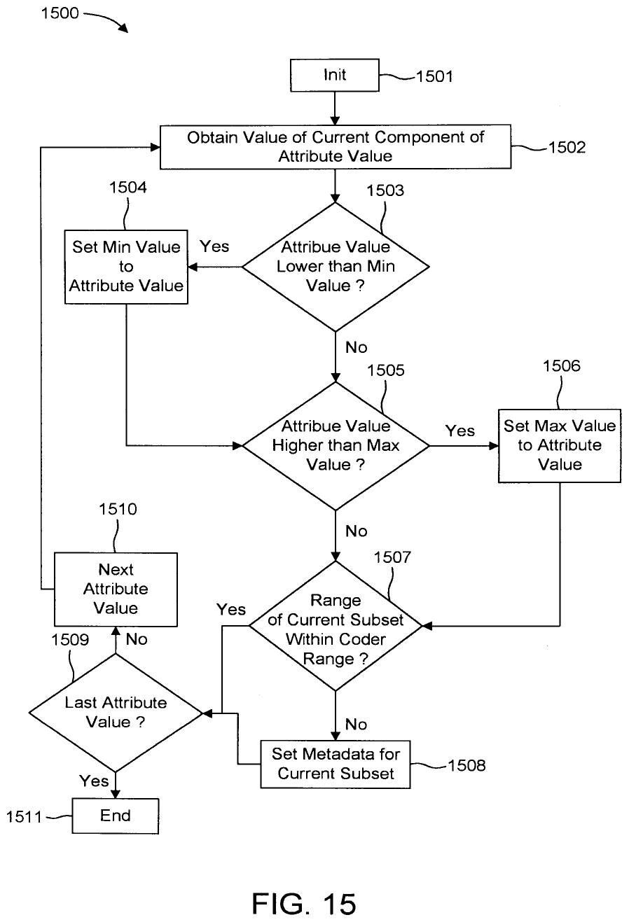

FIG. 15 illustrates of a method 1500 for obtaining the modified attribute at second bit-depth values and the corresponding metadata, according to the sliding size window embodiment.

At 1501, some variables are initialized as follows:
attIdx is the index of a current attribute value in the sequence of attribute values, it is initially set to 0.
c is the component number of the attribute (0, 1 or 2 for Position; 0 or 1 for UV coordinates).
att is the value of the component c of the attribute indexed with attIdx (at position attIdx in the sequence of attributes values).
firstIndex is the index of the first attribute of a current subset, it is initially set to 0.
nextIndex is the index of the first attribute of a next subset
minValue is the minimum value of the attribute's component of the current subset, it is initially set to attribute value of the first attribute value of the sequence for the component c considered.
maxValue is the maximum value of the attribute's component of the current subset, it is initially set to attribute value of the first attribute value of the sequence for the component considered.
rangeBit is the bit depth of the video encoder used to encode the attributes video (Isb)
idxTable[c] is one table per attribute's component that stores the index of the first attributes of each subset,
MinTable[c] is one table per attribute's component that stores the minimum attributes value of each subset.

At 1502, the attribute value at current index attIdx is obtained for the component c considered. At 1503, it is checked whether the attribute value is lower than the minValue. If yes, then at 1504 the minValue is set to the attribute value and the process goes to 1505. If not, the process goes directly to 1505 wherein it is checked whether the attribute value is higher than the maxValue. If yes, then at 1506 the maxValue is set to the attribute value and the process goes to 1507. If not, the process goes directly to 1507 wherein it is checked whether the range of the current subset is within the coder range. For instance, at 1507, it is checked whether the difference between maxValue and minValue (maxValue-minValue) is lower than (2>>rangeBit).

If this is the case, then the range of values of the current subset is within the coder range, so the current attribute value belongs to the current subset and the process goes to the next attribute value. For that, at 1509, it is checked whether all the attribute values of the component have been parsed. If not, then at 1510, the index position is increased by 1 (attIdx=attIdx+1) and the variable prevMinValue is set to minValue.

If at 1507, it is determined that the range of values of the current subset is not within the coder range, then a new subset has to be started. At 1508, the metadata for the current subset are stored. For that, the first index (firstIndex) of the subset is stored in an index table, the value stored in the prevMinValue variable is stored in a table storing the minimum attribute value of each subset.

The modified attribute values whose range is reduced with respect to the original range of the attribute values are determined for the subset. For that all attribute values of the current subset are parsed, and each attribute value is modified by subtracting the minimum value determined for the subset from the attribute value:
att-prevMinValue where att is the attribute value and prevMinValue is the minimum value stored for the current subset. Thus, the modified attribute values can be represented at a bit-depth that is lower than their original bit-depth.

The modified attribute values are stored in the video buffer for subsequence video encoder.

Then, a next subset is initialized by setting the firstIndex to the index of the current attribute value, the minValue to the current attribute value and the maxValue to the current attribute value.

Then, the process goes to 1509 to check whether all the attribute values of the component have been parsed. When all attribute values for the component c haven been parsed, the metadata for the last subset are stored if the metadata has been stored at 1508 and the process ends at 1511.

The method 1500 is performed separately for each component of an attribute, so that separate metadata and subsets are obtained for each component of an attribute.

As for method 1200, the method 1500 is performed for at least one attribute of the 3D object. It can be performed for only one kind of attributes: for instance, for only the positions or for only the UV coordinates, or it can be iterated on each one of the attributes of the 3D object.

On the decoder side, the attribute values of each subset are reconstructed by adding the minimum value decoded from the metadata associated to the subset to the attribute values decoded for the subset.

Some results are provided below. Table 1 shows results for Sliding Size window variant. Some results of the Fixed Size window variant are presented in Table 2 wherein the dynamic of the MSB and index values is limited to 8 bits. In the two tables, the columns description are the followings:
nbcomp is the number of components per attribute type
maxBit is the quantization value used to produce the input sequence, that is the input bit depth of the values)
rangeBit is the bit-depth of the video encoder used to encode the attribute video, e.g. 10 bits for HEVC main10
inputCount is the number of attributes (5^{th} column)
originalSize (6^{th} column) is the size of the original attribute streams: inputCount*maxBit*nbComp
filteredSize (7^{th} column) is the size in bits of the attribute streams after the use of the splitting method: inputCount*rangeBit*nbComp+metaDataSize
metaDataSize (8^{th} column) is the size in bits of the metadata
ratio is the ration between filteredSize and originalSize
nbChuncks the number of generated clusters/subsets

TABLE 1

| | | max- | range- | input- | original- | filtered- | | | |
|---|---|---|---|---|---|---|---|---|---|
| filename | nbComp | Bit | Bit | Count | Size | Size | metaDataSize | ratio | nbChuncks |
| longdress_POSITION_q11_CL7 | 3 | 11 | 10 | 19984 | 659472 | 599763 | 243 | 90.95% | 9 |
| longdress_POSITION_q12_CL7 | 3 | 12 | 10 | 19984 | 719424 | 603496 | 3976 | 83.89% | 142 |
| longdress_TEX_COORD_q12_CL7 | 2 | 12 | 10 | 21456 | 514944 | 434552 | 5432 | 84.39% | 194 |
| longdress_TEX_COORD_q13_CL7 | 2 | 13 | 10 | 21456 | 557856 | 447245 | 18125 | 80.17% | 625 |
| soldier_POSITION_q11_CL7 | 3 | 11 | 10 | 19890 | 656370 | 597132 | 432 | 90.97% | 16 |
| soldier_POSITION_q12_CL7 | 3 | 12 | 10 | 19890 | 716040 | 600172 | 3472 | 83.82% | 124 |
| soldier_TEX_COORD_q12_CL7 | 2 | 12 | 10 | 22606 | 542544 | 458028 | 5908 | 84.42% | 211 |
| soldier_TEX_COORD_q13_CL7 | 2 | 13 | 10 | 22606 | 587756 | 468389 | 16269 | 79.69% | 561 |
| basketball_player_POSITION_q11_CL7 | 3 | 11 | 10 | 19760 | 652080 | 592962 | 162 | 90.93% | 6 |
| basketball_player_POSITION_q12_CL7 | 3 | 12 | 10 | 19760 | 711360 | 594256 | 1456 | 83.54% | 52 |
| basketball_player_TEX_COORD_q12_CL7 | 2 | 12 | 10 | 20691 | 496584 | 417264 | 3444 | 84.03% | 123 |
| basketball_player_TEX_COORD_q13_CL7 | 2 | 13 | 10 | 20691 | 537966 | 426638 | 12818 | 79.31% | 442 |
| dancer_POSITION_q11_CL7 | 3 | 11 | 10 | 19679 | 649407 | 590532 | 162 | 90.93% | 6 |
| dancer_POSITION_q12_CL7 | 3 | 12 | 10 | 19679 | 708444 | 592890 | 2520 | 83.69% | 90 |
| dancer_TEX_COORD_q12_CL7 | 2 | 12 | 10 | 20677 | 496248 | 417124 | 3584 | 84.06% | 128 |
| dancer_TEX_COORD_q13_CL7 | 2 | 13 | 10 | 20677 | 537602 | 426532 | 12992 | 79.34% | 448 |
| mitch_POSITION_q11_CL7 | 3 | 11 | 10 | 15002 | 495066 | 450303 | 243 | 90.96% | 9 |
| mitch_POSITION_q12_CL7 | 3 | 12 | 10 | 15002 | 540072 | 451992 | 1932 | 83.69% | 69 |
| mitch_TEX_COORD_q12_CL7 | 2 | 12 | 10 | 16308 | 391392 | 329184 | 3024 | 84.11% | 108 |
| mitch_TEX_COORD_q13_CL7 | 2 | 13 | 10 | 16308 | 424008 | 338543 | 12383 | 79.84% | 427 |
| thomas_POSITION_q11_CL7 | 3 | 11 | 10 | 14991 | 494703 | 449892 | 162 | 90.94% | 6 |
| thomas_POSITION_q12_CL7 | 3 | 12 | 10 | 14991 | 539676 | 450934 | 1204 | 83.56% | 43 |
| thomas_TEX_COORD_q12_CL7 | 2 | 12 | 10 | 16142 | 387408 | 324996 | 2156 | 83.89% | 77 |
| thomas_TEX_COORD_q13_CL7 | 2 | 13 | 10 | 16142 | 419692 | 333019 | 10179 | 79.35% | 351 |
| football_POSITION_q11_CL7 | 3 | 11 | 10 | 19998 | 659934 | 600210 | 270 | 90.95% | 10 |
| football_POSITION_q12_CL7 | 3 | 12 | 10 | 19998 | 719928 | 601816 | 1876 | 83.59% | 67 |
| football_TEX_COORD_q12_CL7 | 2 | 12 | 10 | 23897 | 573528 | 483932 | 5992 | 84.38% | 214 |
| football_TEX_COORD_q13_CL7 | 2 | 13 | 10 | 23897 | 621322 | 488061 | 10121 | 78.55% | 349 |

TABLE 2

| | | max- | range- | input- | original- | filtered- | | | |
|---|---|---|---|---|---|---|---|---|---|
| filename | nbComp | Bit | Bit | Count | Size | Size | metaDataSize | ratio | nbChuncks |
| longdress_POSITION_q11_CL7 | 3 | 11 | 10 | 19984 | 659472 | 600368 | 2288 | 91.04% | 143 |
| longdress_POSITION_q12_CL7 | 3 | 12 | 10 | 19984 | 719424 | 601810 | 6160 | 83.65% | 385 |
| longdress_TEX_COORD_q12_CL7 | 2 | 12 | 10 | 21456 | 514944 | 432276 | 8416 | 83.95% | 526 |
| longdress_TEX_COORD_q13_CL7 | 2 | 13 | 10 | 21456 | 557856 | 436904 | 20784 | 78.32% | 1299 |
| soldier_POSITION_q11_CL7 | 3 | 11 | 10 | 19890 | 656370 | 597514 | 2224 | 91.03% | 139 |
| soldier_POSITION_q12_CL7 | 3 | 12 | 10 | 19890 | 716040 | 601074 | 11664 | 83.94% | 729 |
| soldier_TEX_COORD_q12_CL7 | 2 | 12 | 10 | 22606 | 542544 | 456296 | 11136 | 84.10% | 696 |
| soldier_TEX_COORD_q13_CL7 | 2 | 13 | 10 | 22606 | 587756 | 461012 | 23712 | 78.44% | 1482 |
| basketball_player_POSITION_q11_CL7 | 3 | 11 | 10 | 19760 | 652080 | 593398 | 1648 | 91.00% | 103 |
| basketball_player_POSITION_q12_CL7 | 3 | 12 | 10 | 19760 | 711360 | 596998 | 11248 | 83.92% | 703 |
| basketball_player_TEX_COORD_q12_CL7 | 2 | 12 | 10 | 20691 | 496584 | 416564 | 7344 | 83.89% | 459 |
| basketball_player_TEX_COORD_q13_CL7 | 2 | 13 | 10 | 20691 | 537966 | 420156 | 16896 | 78.10% | 1056 |
| dancer_POSITION_q11_CL7 | 3 | 11 | 10 | 19679 | 649407 | 590912 | 1472 | 90.99% | 92 |
| dancer_POSITION_q12_CL7 | 3 | 12 | 10 | 19679 | 708444 | 594638 | 11408 | 83.94% | 713 |
| dancer_TEX_COORD_q12_CL7 | 2 | 12 | 10 | 20677 | 496248 | 416948 | 9088 | 84.02% | 568 |
| dancer_TEX_COORD_q13_CL7 | 2 | 13 | 10 | 20677 | 537602 | 421384 | 20944 | 78.38% | 1309 |
| mitch_POSITION_q11_CL7 | 3 | 11 | 10 | 15002 | 495066 | 450888 | 2208 | 91.08% | 138 |
| mitch_POSITION_q12_CL7 | 3 | 12 | 10 | 15002 | 540072 | 454164 | 10944 | 84.09% | 684 |
| mitch_TEX_COORD_q12_CL7 | 2 | 12 | 10 | 16308 | 391392 | 329388 | 8608 | 84.16% | 538 |
| mitch_TEX_COORD_q13_CL7 | 2 | 13 | 10 | 16308 | 424008 | 332636 | 17296 | 78.45% | 1081 |
| thomas_POSITION_q11_CL7 | 3 | 11 | 10 | 14991 | 494703 | 450256 | 1456 | 91.02% | 91 |
| thomas_POSITION_q12_CL7 | 3 | 12 | 10 | 14991 | 539676 | 452196 | 6576 | 83.79% | 411 |
| thomas_TEX_COORD_q12_CL7 | 2 | 12 | 10 | 16142 | 387408 | 325848 | 8048 | 84.11% | 503 |
| thomas_TEX_COORD_q13_CL7 | 2 | 13 | 10 | 16142 | 419692 | 329052 | 16592 | 78.40% | 1037 |
| football_POSITION_q11_CL7 | 3 | 11 | 10 | 19998 | 659934 | 600844 | 2464 | 91.05% | 154 |
| football_POSITION_q12_CL7 | 3 | 12 | 10 | 19998 | 719928 | 604138 | 11248 | 83.92% | 703 |
| football_TEX_COORD_q12_CL7 | 2 | 12 | 10 | 23897 | 573528 | 482388 | 11888 | 84.11% | 743 |
| football_TEX_COORD_q13_CL7 | 2 | 13 | 10 | 23897 | 621322 | 487636 | 25856 | 78.48% | 1616 |

Back to FIG. 7, steps 701 of obtaining the modified values at the second bit-depth and 702 of obtaining the metadata can be performed according to any one of the embodiments described in relation with FIG. 9-15 described above. When encoding the modified attribute values and the metadata at 703, further information can also be encoded such as for instance an information indicating a mode (fixed size window or sliding size window) used for obtaining the metadata and the modified attribute values, a number of attributes of the 3D object, a number of bits used for coding in the metadata the information representative of the modification applied to the attribute values of the at least one subset to obtain the modified attribute values at the second bit-depth, a number of bits used for coding the index in the metadata, a number of information representative of the modification applied to the attribute values of the at least one subset to obtain the modified attribute values at the second bit-depth encoded in the metadata.

Examples of syntax for standard bitstreams are shown below. It is to be noted that these syntax are only examples and other forms can be used, with more or less syntax elements from the ones described below.

TABLE 3

| | Descriptor |
|---|---|
| meta_data_set( ) { | |
| num_attributes | u(32) |
| data_bit_depth | u(8) |
| indices_bit_depth | u(8) |
| splitting_mode | u(1) |
| for( i = 0; i < num_attributes; i++ ) { | |
| if (splitting_mode == SLIDING) { | |
| for( c = 0; c < number_components; c++ ) { | |
| num_chunks[i][c] | u(32) |
| for( j = 0; j < num_chunks[i][c]; j++ ) { | |
| chunk_data[i][c][j] | u(data_bit_depth) |
| } | |
| for( j = 0; j < num_chunks[i][c]; j++ ) { | |
| chunk_indices[i][c][j] | u(indices_bit_depth) |
| } | |
| } | |
| } | |
| if (splitting_mode == MSB) { | |
| num_chunks | u(32) |
| for( j = 0; j < num_chunks; j++ ) { | |
| chunk_data[i][i] | u(data_bit_depth) |
| } | |
| for( j = 0; j < num_chunks; j++ ) { | |
| chunk_indices[i][j] | u(indices_bit_depth) |
| } | |
| } | |
| } | |

Table 3 above shows examples of syntax element for both variants, wherein one meta_data_set table is used for each attribute type. In this embodiment, a splitting mode (splitting_mode) is indicated to specify which splitting method is used for an attribute type. In some embodiments, the metadata information for all attribute types could be sent in a same metadata set, the splitting_mode could be specified for each attribute type, or a splitting_mode could be specified once and used for all types of attributes.

Hereafter, the description of the syntax elements:
splitting_mode: splitting method used, for instance a value 0 indicates the fixed size window, a value 1 indicates the sliding window. Other methods could also be used and signaled, the splitting_mode would then be coded on more than 1 bit.
num_attributes: number of attribute values
data_bit_depth: number of bits for coding the MSB in fixed size window or the minimum value for the sliding window
indexes_bit_depth: number of bits for coding the indexes
num_chunks: in MSB mode the number of chunks
num_chunks [i][c]: in sliding mode, the number of chunks per attribute and per component, with i as attribute index and c is the component number of the attribute.
chunk_data[i]: chunk data array (MSB data for fixed mode, minimum attribute value of the subset for sliding mode)
chunk_indices[i]: chunk indices array (position in the sequence of values of the first value of the subset).

Table 4 and table 5 below illustrate an example of chunk data container and data chunk index container respectively for the fixed size window mode, n is the number of chunks.

TABLE 4

| Att data | |
|---|---|
| 0 | MSB X₀ |
| | MSB Y₀ |
| | MSB Z₀ |
| | MSB X₁ |
| | MSBy₁ |
| | MSBz₁ |
| | . . . |
| | MSBxₙ₋₁ |
| | MSByₙ₋₁ |
| | MSBzₙ₋₁ |
| 1 | MSB U₀ |
| | MSB V₀ |
| | MSB U₁ |
| | MSB V₁ |
| | MSB U₂ |
| | MSB V₂ |
| | . . . |
| | . . . |
| | MSB Uₙ₋₁ |
| | MSB Vₙ₋₁ |

TABLE 5

| Att index | |
|---|---|
| 0 | Index₀ |
| | Index₁ |
| | Index₂ |
| | . . . |
| | indexₙ₋₁ |
| 1 | Index₀ |
| | Index₁ |
| | Index₂ |
| | . . . |
| | indexₙ₋₁ |

Table 6 and table 7 below illustrate an example of chunk data container and chink index container respectively for the sliding window mode, (m,n,t) gives the number of chunks per component:
m is num_chunks[i][0]
n is num_chunks[i][1]
t is num_chunks [i][2]

TABLE 6

| | Component | |
|---|---|---|
| Att index | Id | value |
| 0 | 0 | MIN X₀ |
| | | MIN X₁ |
| | | . . . |
| | | MIN Xₘ₋₁ |
| | 1 | MIN Y₀ |
| | | MIN Y₁ |
| | | . . . |
| | | MIN Yₙ₋₁ |
| | 2 | MIN Z₀ |
| | | MIN Z₁ |
| | | . . . |
| | | MIN Zₜ₋₁ |
| 1 | 0 | MIN U₀ |
| | | MIN U₁ |
| | | . . . |
| | | MIN Uₘ₋₁ |
| | 1 | MIN V₀ |
| | | MIN V₁ |
| | | . . . |
| | | MIN Vₙ₋₁ |

TABLE 7

| | Component | |
|---|---|---|
| Att index | Id | value |
| 0 | 0 | index X₀ |
| | | index X₁ |
| | | . . . |
| | | index Xₘ₋₁ |
| | 1 | index Y₀ |
| | | index Y₁ |
| | | . . . |
| | | index Yₘ₋₁ |
| | 2 | index Z₀ |
| | | index Z₁ |
| | | . . . |
| | | index Zₘ₋₁ |
| 1 | 0 | index U₀ |
| | | index U₁ |
| | | . . . |
| | | index Uₘ₋₁ |
| | 1 | index V₀ |
| | | index V₁ |
| | | . . . |
| | | index Vₘ₋₁ |

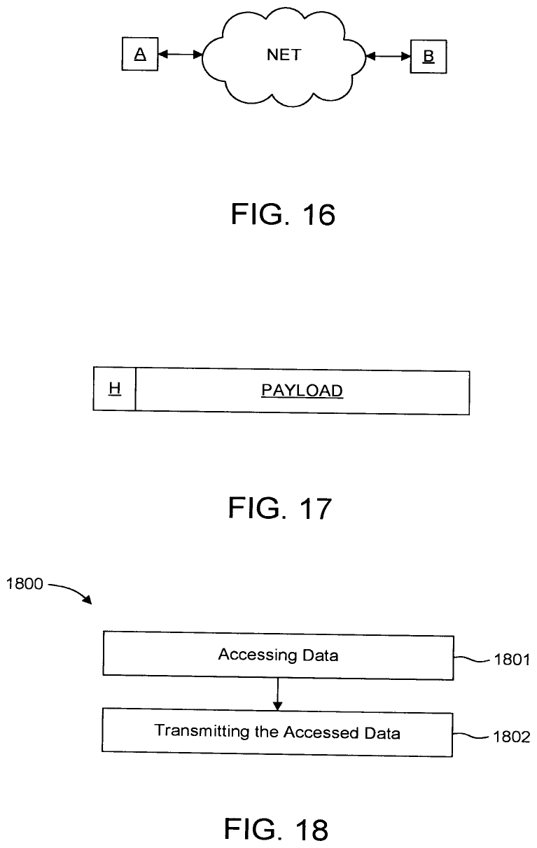

According to an example of the present principles, illustrated in FIG. 16, in a transmission context between two remote devices A and B over a communication network NET, the device A comprises a processor in relation with memory RAM and ROM which are configured to implement a method for encoding a 3D object according to an embodiment as described in relation with the FIGS. 1-15 and the device B comprises a processor in relation with memory RAM and ROM which are configured to implement a method for decoding a 3D object according to an embodiment as described in relation with FIGS. 1-15.

In accordance with an example, the network is a broadcast network, adapted to broadcast/transmit a signal from device A to decoding devices including the device B.

A signal, intended to be transmitted by the device A, carries at least one bitstream generated by the method for encoding a 3D object according to any one of the embodiments described above.

FIG. 17 shows an example of the syntax of such a signal transmitted over a packet-based transmission protocol. Each transmitted packet P comprises a header H and a payload PAYLOAD. According to embodiments, the signal comprises coded metadata associated to at least one subset of attribute values of at least one attribute of the 3D object, the attribute values being represented at a first bit-depth, the metadata comprising an information representative of a modification applied to the attribute values of the at least one subset to obtain modified attribute values at a second bit-depth that is smaller than the first bit-depth, and coded video data representative of the modified attribute values of the at least one subset.

According to embodiments, the signal may comprise at least one of an information indicating a mode used for obtaining the metadata and the modified attribute values, a number of attributes of the 3D object, a number of bits used for coding in the metadata, the information representative of the modification applied to the attribute values of the at least one subset to obtain the modified attribute values at the second bit-depth, a number of bits used for coding the index in the metadata, a number of information representative of the modification applied to the attribute values of the at least one subset to obtain the modified attribute values at the second bit-depth encoded in the metadata.

FIG. 18 illustrates an embodiment of a method (1800) for transmitting a signal according to any one of the embodiments described above. Such a method comprises accessing data (1801) comprising such a signal and transmitting the accessed data (1802) via a communication channel that may be implemented, for example, within a wired and/or a wireless medium. According to an embodiment, the method can be performed by the device 100 illustrated on FIG. 1 or device A from FIG. 16.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of embodiments have been described above. Features of these embodiments can be provided alone or in any combination, across various claim categories and types.

1. A method, comprising, for one or more components of a three dimensional (3D) object having a sequence of attribute values represented at a first bit-depth:
splitting the sequence of attribute values into at least one sub-sequence of attribute values;
obtaining metadata associated to the at least one sub-sequence of attribute values, the metadata comprising a minimum attribute value among the attribute values of the at least one sub-sequence and an index of a first attribute value of the at least one sub-sequence indicating a location of the first attribute value in the sequence of attribute values;
obtaining modified attribute values for the at least one sub-sequence of the sequence of attribute values by subtracting the minimum attribute from attributes values of the at least one sub-sequence, the modified attribute values being represented at a second bit-depth that is smaller than the first bit-depth; and
encoding the modified attribute values and the metadata.

2. An apparatus, comprising one or more processors, wherein said one or more processors are configured to, for one or more components of a three dimensional (3D) object having a sequence of attribute values represented at a first bit-depth:
split the sequence of attribute values into at least one sub-sequence of attribute values;
obtain metadata associated to the at least one sub-sequence of attribute values, the metadata comprising a minimum attribute value among the attribute values of the at least one sub-sequence and an index of a first attribute value of the at least one sub-sequence indicating a location of the first attribute value in the sequence of attribute values;
obtain modified attribute values for the at least one sub-sequence of the sequence of attribute values by subtracting the minimum attribute from attributes values of the at least one sub-sequence, the modified attribute values being represented at a second bit-depth that is smaller than the first bit-depth, and
encode the modified attribute values and the metadata.

3. (canceled)

4. The method of claim 1, wherein the metadata is encoded in a supplemental enhancement information (SEI) message of a video-based encoder.

5-8. (canceled)

9. The method of claim 1, wherein for the sequence of attribute values comprising at least two components, a same metadata is associated to all components of the attribute values of the at least one sub-sequence.

10. The method of claim 1, wherein for the sequence of attribute values comprising at least two components, distinct metadata is associated to each component of the attribute values for the at least one sub-sequence.

11-18. (canceled)

19. A method, comprising:
decoding at least one sub-sequence of a sequence of attribute values of one or more components of a three dimensional (3D) object, and metadata associated to the at least one sub-sequence, the metadata comprising a minimum attribute value among the attribute values of the at least one sub-sequence and an index of a first attribute value of the at least one sub-sequence indicating a location of the first attribute value in the sequence of attribute values, the decoded attribute values being represented at a second bit-depth smaller than a first bit-depth; and
obtaining reconstructed attribute values for the sequence using the metadata and the decoded attribute values of the at least one sub-sequence by adding the minimum value to the decoded attribute values of the at least one sub-sequence, the reconstructed attribute being represented at the first bit-depth.

20. An apparatus comprising one or more processors configured to:
decode at least one sub-sequence of a sequence of attribute values of one or more components of a three dimensional (3D) object, and metadata associated to the at least one sub-sequence, the metadata comprising a minimum attribute value among the attribute values of the at least one sub-sequence and an index of a first attribute value of the at least one sub-sequence indicating a location of the first attribute value in the sequence of attribute values, the decoded attribute values being represented at a second bit-depth smaller than a first bit-depth; and
obtain reconstructed attribute values for the sequence using the metadata and the decoded attribute values of the at least one sub-sequence, the reconstructed attribute being represented at the first bit-depth.

21. The method of claim 19, wherein the attribute values are decoded using a video-based decoder operating at the second bit-depth.

22. The method of claim 19, wherein the metadata is decoded from a supplemental enhancement information (SEI) message of a video-based decoder.

23. The method of claim 19, further comprising unpacking the attribute values from at least one component of an image of a video.

24-26. (canceled)

27. The method of claim 19, further comprising decoding at least one of:
an information indicating a mode used for obtaining the metadata and the modified attribute values;
a number of attribute value of the 3D object;
a number of bits used for coding in the metadata, the information representative of the modification applied to the attribute values of the at least one subset to obtain the modified attribute values at the second bit-depth;
a number of bits used for coding the index in the metadata; and
a number of information representative of the modification applied to the attribute values of the at least one subset to obtain the modified attribute values at the second bit-depth encoded in the metadata.

28. The method of claim 1, wherein attributes values are one of the following types: geometry coordinates of points of the 3D object, texture coordinates of points of the 3D object in a frame atlas, normal coordinates, and color data.

29. The method of claim 19, wherein the 3D object is a 3D mesh.

30. A computer readable storage medium having stored thereon instructions for causing one or more processors to perform the method of claim 1.

31. The apparatus according to claim 20, further comprising
at least one of (i) an antenna configured to receive a signal, the signal including data representative of at least one part of a 3D object, (ii) a band limiter configured to limit the received signal to a band of frequencies that includes the data representative of the at least one part of the 3D object, or (iii) a display configured to display the at least one part of the 3D object.

32. The apparatus according to claim 31, comprising a television (TV), a cell phone, a tablet or a set top box.

33. A computer readable storage medium having stored thereon a bitstream comprising:
coded metadata associated to at least one subset of attribute values of a three dimensional (3D) object, the attribute values being represented at a first bit-depth, the metadata comprising an information representative of a modification applied to the attribute values of the at least one subset to obtain modified attribute values at a second bit-depth that is smaller than the first bit-depth; and
coded video data representative of the modified attribute values of the at least one subset.

34. The computer readable storage medium of claim 33, wherein the bitstream further comprises at least one of:
an information indicating a mode used for obtaining the metadata and the modified attribute values;
a number of attribute values of the 3D object;
a number of bits used for coding in the metadata, the information representative of the modification applied to the attribute values of the at least one subset to obtain the modified attribute values at the second bit-depth;
a number of bits used for coding an index in the metadata; and
a number of information representative of the modification applied to the attribute values of the at least one subset to obtain the modified attribute values at the second bit-depth encoded in the metadata.

35-36. (canceled)

37. The apparatus of claim 20, wherein the attribute values are decoded using a video-based decoder operating at the second bit-depth.

38. The apparatus of claim 20, wherein the metadata is decoded from a SEI message of a video-based decoder.
